(19) United States
(12) Patent Application Publication
(10) Pub. No.: US 2010/0260456 A1
(43) Pub. Date: Oct. 14, 2010

(54) INTERCONNECTION SYSTEM

(75) Inventors: Franck ALCARAZ, Grenoble (FR); Renaud DURAND, Grenoble (FR)

Correspondence Address: OLIFF & BERRIDGE, PLC, P.O. BOX 320850, ALEXANDRIA, VA, 22320-4850, US

(73) Assignee: RADIALL, Rosny Sous Bois (FR)

(21) Appl. No.: 12/752,686

(22) Filed: Apr. 1, 2010

(30) Foreign Application Priority Data
Apr. 8, 2009 (FR) 09 52295

(51) Int. Cl. G02B 6/36

(52) U.S. Cl. 385/76

(57) ABSTRACT

The present invention provides a plug comprising:
at least one contact connected to a cable;
a body within which the contact(s) is/are received; and
a gland holding the plug on the cable;
the contact(s) being received in floating manner inside the body, the body extending along a longitudinal axis, and the body including a cantilevered out middle portion and a tubular front portion extending around the longitudinal axis beyond the middle portion.

### FIELD OF THE INVENTION

The present invention relates to a connection system and to the components of such a system.

The invention applies more particularly to making a connector for Ethernet applications in a severe external environment.

### BACKGROUND OF THE INVENTION

It is known, e.g. from U.S. Pat. Nos. 7,338,214 and 7,281,856, to provide optical connector plugs including LC optical contacts that are received in a support that incorporates them and that holds them inside the plug.

Having recourse to such a support may require special tooling to be used and thus complicate the cabling work of an installer. Furthermore, since the rear portion of an LC contact is not standardized, it may differ from one product to another and require a specific support, thereby limiting any possibility of an installer using different LC contact references and also preventing said installer being able to reuse existing cords.

It is also known, e.g. from US application No. 2007/0036489, to place an optoelectronic converter, also referred to as a transceiver, that is mounted on a support in a base that is fastened to the panel of a piece of client equipment, and to connect the support by means of a cable to the printed circuit of the client equipment.

The use of such a cable connecting the printed circuit of the client equipment to the optoelectronic converter may present drawbacks such as the use of additional components, an increase in cost, and increased complexity during assembly.

### OBJECT AND BRIEF SUMMARY OF THE INVENTION

There exists a need to remedy the above-mentioned drawbacks, and exemplary embodiments of the invention achieve this by means of a plug comprising:

at least one contact connected to a cable;

a body within which the contact(s) is/are received; and

a gland holding the plug on the cable;

the contact(s) being received in floating manner inside the body, the body extending along a longitudinal axis, and the body including a cantilevered out middle portion and a tubular front portion extending beyond the middle portion around the longitudinal axis.

The contact(s) is/are received in floating manner inside the body, i.e. the body is advantageously lacking in any part that supports said contact(s). By way of example, the optical contact(s) is/are carried solely by the cable, unlike the solutions proposed in U.S. Pat. Nos. 7,281,856 and 7,338,214, in which the contacts are carried by a support clipped onto the body.

By avoiding having recourse to a support for the contact(s), the invention makes it possible to use any existing type of cord, without there being any need to provide a support that is specific to some particular type of contact, thus making it possible for example to set up equipment using already-existing cords and without using special tooling.

The contacts may be optical contacts or they may be plugs of various kinds such as, for example: RJ45 or USB plugs.

The cantilevered out middle portion may be different from two diametrically opposite beams. Said middle portion may be made of one or several beams positioned inside a same fraction of the periphery of the body. Said fraction extends for example angularly over less than 180°, better less than 150°, better less than 120°, better less than 90°, better less than 60°, around the longitudinal axis of said body.

The middle portion of the body is advantageously constituted by a single beam.

The tubular front portion of the body extends beyond the middle portion around the longitudinal axis, i.e. it projects angularly relative to the middle portion in at least one direction. By way of example, the tubular front portion extends on either side of the middle portion around the longitudinal axis, e.g. over more than half the periphery of the body.

Advantageously, the tubular front portion of the body is open over at least a fraction of its periphery.

A middle portion and a front portion of these exemplary embodiments of the invention makes it possible, for example, for an installer to pass contacts easily inside the body and to access the contacts easily, e.g. while performing operations of connecting the contacts to a base.

Advantageously, the tubular front portion of the body includes at least one stud arranged on its outside surface. By way of example, the tubular front portion of the body has two studs, e.g. two studs that are diametrically opposite on the front portion of the body.

Advantageously, the body also includes a tubular rear portion on which the gland is mounted.

Advantageously, the gland has means enabling a sealed mechanical connection to be established between the plug and the cable, while also serving to accompany the cable in bending.

By way of example, the gland comprises at least one annular gasket pressed against the cable.

By way of example, the gland comprises two holder half-elements against the cable together with a clamping element clamping the half-elements.

By way of example, the gland comprises a nut having a front portion for mounting on the rear portion of the body and a rear portion that is flexible, e.g. comprising a helical structure, said flexible rear portion making it possible to accompany the cable in bending.

Advantageously, the plug includes a dust cap surrounding the outside of the body, the cap serving to protect the body and the contact from the outside environment.

Advantageously, the cap includes at least one stud formed on its inside surface. By way of example, the cap has two studs, the studs being disposed diametrically opposite each other on the cap, for example.

Other exemplary embodiments of the invention also provide an assembly comprising:

a socket comprising a tubular portion and a plate for fastening to a panel; and

a piece of client equipment comprising a unit with at least one housing for receiving at least one contact when the base is coupled to a plug, in particular to a plug as defined above;

the unit being received in floating manner inside the tubular portion of the socket, and the tubular portion of the socket including at least one curved slot.

Advantageously, the curved slot occupies the entire thickness of the tubular portion of the socket. Advantageously, the curved slot extends over only a fraction of the periphery of the tubular portion.

The unit including the housings that receive the contacts is advantageously not fastened directly to the socket, but is incorporated in the client equipment.

The unit is received in floating manner inside the tubular portion of the socket, i.e. the socket advantageously does not include a part supporting the unit.

The housings may receive optical contacts, RJ45 contacts, or indeed USB contacts.

By way of example, the client equipment may comprise a chassis, an optoelectronic converter, and a printed circuit card, e.g. serving to constitute a remote antenna head for the telecommunications market.

By way of example, the unit forms part of the optoelectronic converter. The optoelectronic converter may then be received in floating manner inside the tubular portion of the socket, the socket advantageously not having any part supporting said optoelectronic converter.

By way of example, the optoelectronic converter may be held inside the socket solely by the printed circuit of the client equipment, thus making it possible to ensure that the environment in the vicinity of the socket is unencumbered, thereby facilitating mounting, unlike the prior art solution as disclosed for example by US application No. US 2007/0036489, in which the optoelectronic converter is carried by the socket.

The invention may make it possible to connect a plug to the optoelectronic converter incorporated in the client equipment and mounted directly on the printed circuit of the client equipment, without a connection cable.

Advantageously, the socket includes at least one annular gasket placed in a housing formed in the outside surface of the tubular portion, and at least one annular gasket placed in a housing formed in the inside surface of the tubular portion.

By way of example, the tubular portion of the socket has two curved slots that are configured to co-operate with the studs of a plug as defined above while the plug and the socket are being coupled together so as to provide a double-bayonet connection between the plug and the socket.

Because of the presence of the two gaskets in the socket, the double-bayonet connection may provide leaktight locking of the connection between the plug and the socket. In addition, the double-bayonet connection may give the resulting connection system greater ability to withstand external mechanical stresses.

Other exemplary embodiments of the invention also provide a connection system comprising:

a plug comprising at least one contact connected to a cable, a body in which the contact(s) is/are received, a gland holding the plug on the cable, and a dust cap surrounding the outside of the body; and

a socket comprising a tubular portion and a plate for fastening to a panel of a piece of client equipment;

each of the body and the cap of the plug including at least one stud, and the tubular portion of the socket including at least one curved slot configured to receive simultaneously the stud of the body and the stud of the cap.

By way of example, the plug of the stud may prevent the plug of the cap from moving when both these studs are received in the slot.

Advantageously, the studs of the plug and the curved slot of the socket enable a double-bayonet connection to be established between the plug and the socket.

Advantageously, both the body and the cap have two studs each, and advantageously the tubular portion of the base has two curved slots, each curve slot being configured to receive simultaneously one stud of the body and one stud of the cap.

Other exemplary embodiments of the invention provide a connector plug comprising:

at least one contact connected to a cable;

a body extending along a longitudinal axis and having the contact(s) received therein; and

a gland holing the plug on the cable;

the body including a middle portion constituted by a single beam.

Advantageously, such a plug presents an open side surface giving access to the contact(s) from the outside, said open side surface being provided on either side of the beam of the middle portion by one or more openings provided in the side surface of the front portion of the body.

### BRIEF DESCRIPTION OF THE DRAWINGS

Other advantages and characteristics of the invention appear on reading the following description of a non-limiting embodiment, given with reference to the accompanying drawings, in which:

FIG. 1 is a perspective view of an embodiment of the invention;

FIG. 2 is an exploded view of a plug in an embodiment of the invention;

FIG. 3 is a perspective view of an assembly comprising a socket and client equipment in an embodiment of the invention;

FIG. 4 is a section view of the assembly shown in FIG. 3; and

FIGS. 5 and 6 show two steps during a method of coupling a FIG. 2 plug with a FIG. 3 socket.

### MORE DETAILED DESCRIPTION

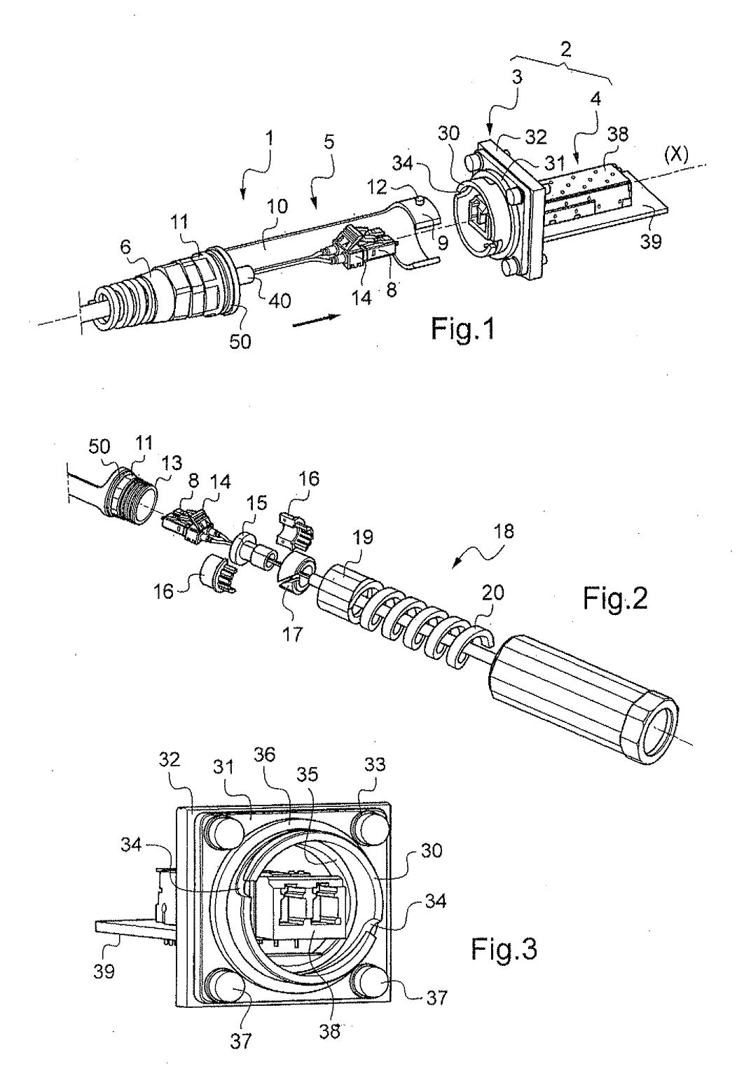

FIG. 1 shows a plug given overall reference 1 and an assembly given overall reference 2, which assembly comprises a socket given overall reference 3 and a piece of client equipment given overall reference 4.

The plug 1 and the socket 3 are configured to be coupled together in order to establish a connection system.

In the example described, the plug 1 comprises a body 5, a gland 6, a dust cap 7, and contacts 8.

In the example described, the contacts 8 are optical contacts, e.g. LC duplex optical contacts, however the invention is not limited to any particular type of contact.

In variants, the contacts are RJ45 or USB contacts.

As can be seen in FIGS. 1 and 2, the optical contacts 8 are received inside the body 5, and at one end these optical contacts 8 are connected to an optical cable 40.

In the example described, two optical contacts 8 are mounted to the optical cable 40, however the invention is not limited to any particular number of contacts.

By way of example, the optical contacts 8 are held together by a plastic clip or strap 14.

The body 5 in the example described extends along a longitudinal axis X and has a front tubular portion 9, a middle portion 10, and a rear tubular portion 11. In the example described, the body 5 comprises a single piece.

By way of example, the body 5 is made of machined aluminum or of brass. In a variant, the body 5 is made by injection molding, e.g. out of injected metal, injected plastics material, in particular a metal-filled plastics material, e.g. containing stainless steel fibers, thereby making it possible to obtain better protection against electromagnetic interference.

As can be seen in FIG. 1, the front portion 9 is open over a portion of its periphery and it includes, on its outside surface, two studs 12 that are diametrically opposite, for example, and that serve to perform a function that is described below.

By way of example, the middle portion 10 is constituted by a single beam extending over only a fraction of the outline of the body 5, such that the side surface of the body 5 in the middle portion 10 is wide open and accessible from the outside.

The invention is not limited to any particular number of beams, it being possible for the middle portion to be constituted by two beams, for example, with the two beams leaving between them an open surface that is accessible from the outside.

As shown in FIG. 1, the tubular front portion 9 may extend around the axis X from either side of the beam(s) of the middle portion 10.

The rear portion 11 extends around the entire periphery of the body and, as can be seen in FIG. 2, it carries a thread 13 on its outside surface and an annular gasket 50 extending all around its outside surface.

As can be seen, the body 5 need not have any support for holding the optical contacts 8, such that the optical contacts are carried by the optical cable 40.

With reference to FIG. 2, there follows a description of a gland 6 in an embodiment of the invention. By way of example, the gland 6 comprises a split gasket 15, e.g. made of silicone, providing a leaktight connection with the optical cable 40, together with two half-elements 16, for example, serving to hold the gland 6 against the optical cable 40, which half-elements may be made of plastics material.

The gland may also include a split clamping cone 17 for holding the two half-elements 16 close on the optical cable 40.

The gland 6 may also include a nut 18, e.g. made of plastics material, having a front portion 19 presenting an inside thread for co-operating with the thread 13 on the rear portion 11 of the body 5, and a rear portion 20 that presents the shape of a flexible structure. In the example described, this flexible structure is helical in shape, and is sometimes referred to as a pigtail.

By way of example, the nut 18 and the holder half-elements 16 present diameters that are different, with it being possible for this difference to be compensated by interposing the split clamping cone 17.

The invention is not limited to a plug that includes a gland of the kind described above. The plug may include any type of gland.

In the example described, the cap 7 is of tubular shape and on its inside surface at its front end it has two studs 21 (visible in FIG. 6) that perform a function that is described below. By way of example, the cap 7 is made of machined aluminum or of brass. In a variant, the cap 7 is made by injection molding, e.g. being made of injected metal, or of injected plastics material, in particular metal-filled plastics material, e.g. containing stainless steel fibers, thus making it possible to obtain better protection against electromagnetic interference.

There follows a description of an example of how to assemble a plug 1 as described above.

The gasket 15 is inserted over a portion of the optical cable 40.

The split clamping cone 17 is inserted over the same portion of the optical contact 40.

The two holder half-elements 16 are placed on either side of the optical cable 40 and the cone 17 is slid until it holds the two half-elements 16 against the optical cable 40.

In a subsequent operation, the nut 18 is screw-fastened onto the rear portion 11 of the body 5.

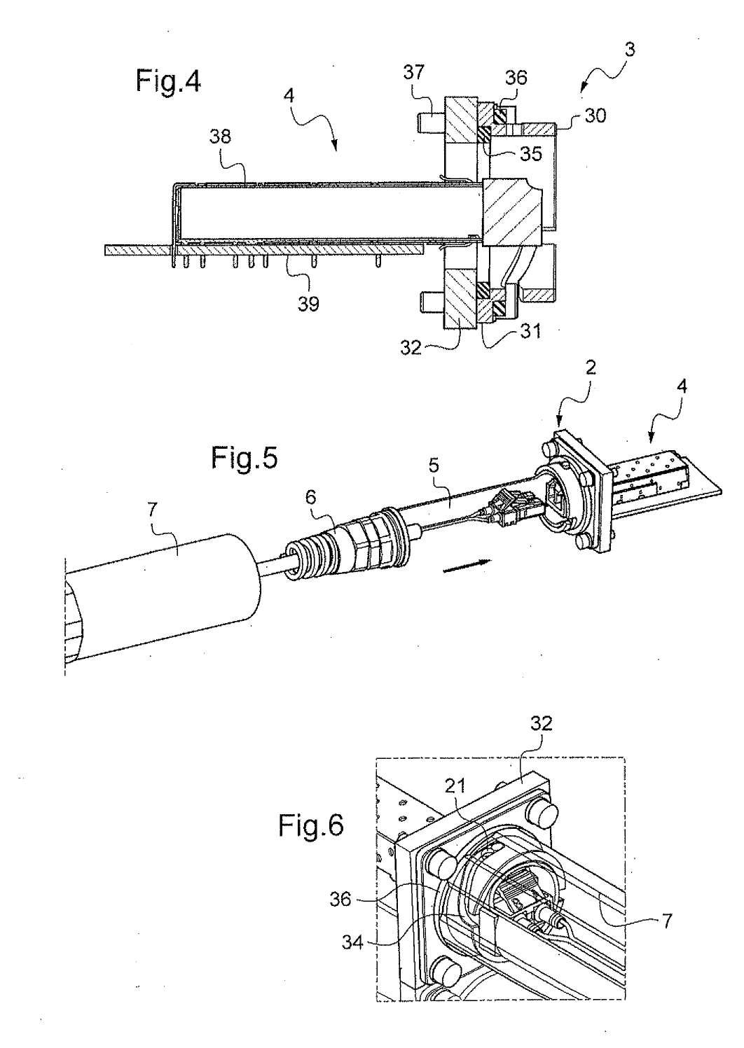

There follows a description with reference to FIGS. 3 and 4 of an example of an assembly 2 of the invention.

The socket 3 comprises a tubular portion 30 and a plate 31 for fastening to a panel 32. In the example shown, the socket 3 comprises a single piece.

By way of example, the plate 31 is square or rectangular in shape and includes openings 33 in its four corners for receiving screws 37 serving to fasten the socket 3 to the panel 32. The invention is naturally not limited to any particular shape for the plate or to any particular number for the openings 33 that pass the screws 37.

In the example described, the tubular portion 31 has two curved slots 34 that are, for example, disposed diametrically opposite around the periphery of the tubular portion 30. By way of example, each groove 34 is formed through the entire thickness of the tubular portion 30 and extends over only a fraction of the periphery of the tubular portion 30.

Two annular gaskets 35 and 36 are disposed respectively against the inside surface and against the outside surface of the tubular portion 30, these gaskets being received in housings formed in said surfaces. The gasket 35 serves to provide sealing relative to the panel 32.

As can be seen in FIG. 3, the piece of client equipment 4 may comprise an optoelectronic converter 38 and a printed circuit card 39, the optoelectronic converter 38 including, for example, a fraction that is received in the opening formed in the tubular portion 30, without being supported by the base 3.

In the example described, the optoelectronic converter 38 is carried by the printed circuit 39, being mounted directly on the printed circuit 39 without any intermediate connection cable.

With reference to FIGS. 5 and 6, there follows a description of an example of coupling a plug 1 as described above to an assembly 2 comprising a socket 3 and client equipment 4, as described above.

During a step as shown in FIG. 5, the body 5 is fastened to the tubular portion 30 of the socket 3 by co-operation between the studs 12 and the curved slots 34. The body 5 then comes to bear against the gasket 35, thereby providing a sealed and elastic connection between the body 5 and the socket 3.

In a subsequent step, the user connects the optical contacts 8 to the optoelectronic converter 35 by accessing the contacts through the open side surfaces of the front and middle portions 9 and 10 of the body 5.

This connection may be established without separating the two contacts 8 from each other, thus avoiding any need to remove the strap 14.

During a subsequent step shown in FIG. 6, the cap 7 is secured to the base 3 by its studs 21 co-operating with the curved slots 34, so as to establish a second bayonet connection. The cap 7 may press against the gasket 36, thereby providing a sealed and resilient connection between the cap 7 and the socket 3.

By way of example, the studs 21 of the cap prevent the studs 12 of the front portion 9 of the body 5 from moving.

Once the cap has been mounted on the socket 3, it compresses the gasket 50 disposed on the rear portion 11 of the body 5, thereby contributing to sealing the connection between the plug and the socket.

The invention is not limited to the examples described above.

The invention makes it possible to be independent of the type and the brand of the contact(s) used and proposes a concept that is universal, reliable, and ergonomic for providing a connector, without requiring any specific tooling.

The term “comprising a” should be understood as being synonymous with “comprising at least one” unless specified to the contrary.

What is claimed is:

1. A plug comprising:
at least one contact connected to a cable;
a body within which the contact(s) is/are received; and
a gland holding the plug on the cable;
the contact(s) being received in floating manner inside the body, the body extending along a longitudinal axis, and the body including a cantilevered out middle portion and a tubular front portion extending around the longitudinal axis beyond the middle portion.

2. A plug according to claim 1, the body including a tubular rear portion on which the gland is mounted.

3. A plug according to claim 1, the middle portion of the body being constituted by a single beam.

4. A plug according to claim 1, the tubular front portion of the body being open over at least a fraction of its periphery.

5. A plug according to claim 1, the tubular front portion of the body including at least one stud provided on its outside surface.

6. A plug according to claim 1, the gland comprising an annular gasket bearing against the cable.

7. A plug according to claim 1, the gland comprising two holder half-elements on the cable and a clamping element clamping the half-element.

8. A plug according to claim 2, the gland comprising a nut having a front portion designed to be mounted on the rear portion of the body, and a rear portion that is flexible.

9. A plug according to claim 1, including a dust cap surrounding the outside of the body.

10. A plug according to claim 9, the cap including at least one stud formed on its inside surface.

11. A plug according to claim 1, the contacts being optical contacts.

12. An assembly comprising:
a socket comprising a tubular portion and a plate configured to be fastened to a panel; and
a piece of client equipment comprising a unit with at least one housing configured to receive at least one contact when the base is coupled to a plug;
the unit being received in floating manner inside the tubular portion of the socket, and the tubular portion of the socket including at least one curved slot.

13. An assembly according to claim 12, the socket including at least one annular gasket placed in a housing formed in the outside surface of the tubular portion, and at least one annular gasket placer in a housing formed in the inside surface of the tubular portion.

14. A connection system comprising:
a plug comprising at least one contact connected to a cable, a body in which the contact(s) is/are received, a gland holding the plug on the cable, and a dust cap surrounding the outside of the body; and
a socket comprising a tubular portion and a plate configured to be fastened to a panel of a piece of client equipment;
each of the body and the cap of the plug including at least one stud, and the tubular portion of the socket including at least one curved slot configured to receive simultaneously the stud of the body and the stud of the cap.
